(19) United States
(12) Patent Application Publication
(10) Pub. No.: US 2017/0250902 A1
(43) Pub. Date: Aug. 31, 2017

(54) CONTROL OF COMMUNICATION USING SERVICE FUNCTION CHAINING

(71) Applicant: NOKIA SOLUTIONS AND NETWORKS OY, Espoo (FI)

(72) Inventors: John Juha Antero RASANEN, Espoo (FI); Mikko Jyrki Olavi KANERVA, Helsinki (FI)

(21) Appl. No.: 15/513,352

(22) PCT Filed: Sep. 23, 2014
(86) PCT No.: PCT/EP2014/070242

§ 371 Date: Mar. 22, 2017

(51) Int. Cl. H04L 12/725; H04L 12/24; H04L 12/813

(52) U.S. Cl. CPC H04L 45/306; H04L 47/20; H04L 41/50

(57) ABSTRACT

An apparatus including at least one processing circuitry, and at least one memory for storing instructions to be executed by the processing circuitry, wherein the at least one memory and the instructions are configured to, with the at least one processing circuitry, cause the apparatus at least: to acquire data indicating at least one available external service function or at least one external service function chain via a predetermined interface, to decide whether at least one of the indicated at least one external service function or at least one external service function chain is usable in a communication of a service data flow in the communication network, to select at least one from the indicated at least one external service function or at least one external service function chain for use on the basis of the decision whether at least one of the advertised at least one external service function or external service function chain is usable in a communication of a service data flow, and to provide, to an external service function providing side, information related to an intended usage of at least one external service function or at least one external service function chain in a service data flow communicated in a communication network. Implements service function chaining and cloud bursting.

### BACKGROUND

Field

The present invention relates to apparatuses, methods, systems, computer programs, computer program products and computer-readable media usable for controlling a communication using service function chaining.

Background Art

The following description of background art may include insights, discoveries, understandings or disclosures, or associations, together with disclosures not known to the relevant prior art, to at least some examples of embodiments of the present invention but provided by the invention. Some of such contributions of the invention may be specifically pointed out below, whereas other of such contributions of the invention will be apparent from the related context.

The following meanings for the abbreviations used in this specification apply:
3GPP 3^{rd} Generation Partnership Project
ACK: acknowledgement
BS: base station
CN: core network
CPU: central processing unit
ADC: application detection and control
AESE: architecture enhancements for service capability
API: application programming interface
D2D: device to device
DL: downlink
eNB: evolved node B
EPC: extended packet core
ETSI: European Telecommunications Standards Institute
FMSS: flexible mobile service steering
GGSN:gateway GPRS support node
GPRS: general packet radio service
GW: gateway
HSS: home subscriber server
ID: identification, identifier
IP: Internet protocol
LTE: Long Term Evolution
LTE-A: LTE Advanced
MMS: multimedia messaging service
NSH: network service header
OMA: open mobile alliance
OSI: open system interconnection
PCEF: policy and charging enforcement function
PCRF: policy and charging rules function
P-GW: packet data network gateway
QoS: quality of service
SCF: service capability function
SDF: service data flow
SF: service (chain) function
SFC: service function controller
SMS: short message service
SPR: subscription profile repository
TDF: traffic detection function
UDR: user data repository
UE: user equipment
UL: uplink
VNF: virtual network function

Embodiments of the present invention are related to a communication system in which a suitable architecture, procedure and protocol are provided related to a functionality allowing usage of external service functions or service functions chains for achieving a flexible mobile service steering.

### SUMMARY

According to an example of an embodiment, there is provided, for example, an apparatus including at least one processing circuitry, and at least one memory for storing instructions to be executed by the processing circuitry, wherein the at least one memory and the instructions are configured to, with the at least one processing circuitry, cause the apparatus at least: to acquire data indicating at least one available external service function or at least one external service function chain via a predetermined interface, to decide whether at least one of the indicated at least one external service function or at least one external service function chain is usable in a communication of a service data flow in the communication network, to select at least one from the indicated at least one external service function or at least one external service function chain for use on the basis of the decision whether at least one of the advertised at least one external service function or external service function chain is usable in a communication of a service data flow, and to provide, to an external service function providing side, information related to an intended usage of at least one external service function or at least one external service function chain in a service data flow communicated in a communication network.

Furthermore, according to an example of an embodiment, there is provided, for example a method including acquiring data indicating at least one available external service function or at least one external service function chain via a predetermined interface, deciding whether at least one of the indicated at least one external service function or at least one external service function chain is usable in a communication of a service data flow in the communication network, selecting at least one from the indicated at least one external service function or at least one external service function chain for use on the basis of the decision whether at least one of the advertised at least one external service function or external service function chain is usable in a communication of a service data flow, and providing, to an external service function providing side, information related to an intended usage of at least one external service function or at least one external service function chain in a service data flow communicated in a communication network.

According to further refinements, these examples may include one or more of the following features:
it may be considered whether at least one own service function of the communication network is usable instead of an indicated external service function or external service function chain, or whether the indicated at least one external service function or at least one external service function chain is applicable as a complement to at least one own service function of the communication network, wherein the decision whether at least one of the indicated at least one external service function or at least one external service function chain is usable in a communication of a service data flow may be based on the consideration;
the data indicating the at least one available external service function or at least one external service function chain via the predetermined interface may include at least one of an indication of a respective external service function or external service function chain, an indication of capabilities of a respective external service function or external service function chain, and an indication of a tag or identification element of a respective external service function or external service function chain;
the information related to the intended usage of at least one external service function or at least one external service function chain may be based on the selection of the at least one of the indicated at least one external service function or external service function chain;
generic service policy rules to be applied to a communication of a service data flow in the communication network may be acquired, wherein the generic service policy rules may be used for routing a service data flow to and within at least one external service function or at least one external service function chain;
the generic service policy rules may include at least one of a static generic service policy rule part and a dynamically changeable generic service policy rule part, wherein the dynamically changeable generic service policy rule part is changeable with regard to an occurrence of a specific event;
it may be detected that an event triggering activation of specific service policy rules being specific to a communication element or user of the communication network, and the specific service policy rules whose activation is triggered may be acquired, wherein the specific service policy rules may be used for routing a service data flow to and within at least one external service function or at least one external service function chain;
the event triggering the activation of the specific service policy rules may include at least one of an attachment of a communication element or user to the communication network, an initiation of an application requiring a service data flow, an activation of a service, an update of a subscription of a communication element or user, a specified time point, an elapse of a specified period of time, a traffic load situation, a change of a location of the communication element or user, and the acquiring of the specific service policy rules may include at least one of generating the specific service policy rules and obtaining pre-stored information indicating the specific service policy rules;
transmission of at least one of generic service policy rules and specific service policy rules to a communication network control element of the attached communication element or user may be caused;
at least one of the generic service policy rules and the specific service policy rules may include parameters related to a marking a data packet, wherein the marking may indicate service functions or service function chains to be used for the data packet;
at least one of generic service policy rules, specific service policy rules and a subscription to at least one service function or at least one service function chain may be updated in response to an indication from at least one of the external service function providing side and the communication network;
the above defined processing may be implemented in a communication network control element configured to act as at least one of a service selection control function and policy and charging rules function, which is connectable to an external service providing side by means of an application programming interface.

In addition, according to an example of an embodiment, there is provided, for example an apparatus including at least one processing circuitry, and at least one memory for storing instructions to be executed by the processing circuitry, wherein the at least one memory and the instructions are configured to, with the at least one processing circuitry, cause the apparatus at least: to obtain, from a communication network, information related to an intended usage, by the communication network, of at least one external service function or at least one external service function chain in a service data flow communicated in a communication network, and to process the information for preparation of the indicated at least one external service function or at least one service function chain for usage in a communication of a service data flow.

Furthermore, according to an example of an embodiment, there is provided, for example a method including obtaining, from a communication network, information related to an intended usage, by the communication network, of at least one external service function or at least one external service function chain in a service data flow communicated in a communication network, and processing the information for preparation of the indicated at least one external service function or at least one service function chain for usage in a communication of a service data flow.

According to further refinements, these examples may include one or more of the following features:
data indicating at least one available external service function or external service function chain via a predetermined interface may be provided, wherein the information related to an intended usage, by the communication network, of at least one external service function or at least one external service function chain may indicate at least one external service function or at least one external service function chain being selected from the indicated external service functions or external service function chains;
the data indicating the at least one available external service function or at least one available external service function chain via the predetermined interface may include at least one of an indication of a respective external service function or external service function chain, an indication of capabilities of a respective external service function or external service function chain, and an indication of a tag or identification element of a respective external service function or external service function chain;
at least one uplink data packet from the communication network may be received, the received uplink data packet may be routed via at least one identified service function or at least one identified service function chain, wherein the identification of the service function or service function chain may be based on routing information including a marking in the data packet, wherein the marking may indicate service functions or service function chains to be used for the data packet, and transmission of the uplink data packet to a destination in the uplink direction may be caused;
at least one uplink data packet from the communication network may be received, the received uplink data packet may be routed via at least one identified service function or at least one identified service function chain, wherein the identification of the service function or service function chain may be based on routing information including a marking in the data packet, wherein the marking may indicate service functions or service function chains to be used for the data packet; and the uplink data packet may be routed back to the communication network for forwarding to a destination;
routing of later uplink data packets of the same service data flow like the received uplink data packet via the at least one identified service function or at least one identified service function chain may be prepared, and an acknowledgement for the routing information to the communication network for enabling a drop of an introduction of the routing information in later uplink data packets of the same service data flow may be provided;
at least one downlink data packet may be received from the communication network, the received downlink data packet may be routed via at least one identified service function or at least one identified service function chain, wherein the identification of the service function or service function chain may be based on routing information including a marking in the data packet, wherein the marking may indicate service functions or service function chains to be used for the data packet and the downlink data packet may be forwarded back to the communication network;
routing of later downlink data packets of the same service data flow like the received downlink data packet via the at least one identified service function or at least one identified service function chain may be prepared, and an acknowledgement for the routing information to the communication network for enabling a drop of the indication of routing information in later downlink data packets of the same service data flow may be provided;
the above defined processing may be implemented in a control element of an external service function providing side, which is connectable to the communication network.

In addition, according to an example of an embodiment, there is provided, for example an apparatus including at least one processing circuitry, and at least one memory for storing instructions to be executed by the processing circuitry, wherein the at least one memory and the instructions are configured to, with the at least one processing circuitry, cause the apparatus at least: to receive and process service policy rules to be used for routing a service data flow to and within at least one external service function or at least one external service function chain; to receive a data packet in at least one of uplink and downlink direction; to determine whether for the received data packet any service policy rules to be used for routing a service data flow to and within at least one external service function or at least one external service function chain are present; in case service policy rules to be used for routing a service data flow to and within at least one external service function or at least one external service function chain are present, to apply the service policy rules to introducing routing information including a marking in the data packet, wherein the marking indicates service functions or service function chains to be used for the data packet; and to route the data packet including the routing information via relevant external service functions or external service function chains.

Furthermore, according to an example of an embodiment, there is provided, for example a method including receiving and processing service policy rules to be used for routing a service data flow to and within at least one external service function or at least one external service function chain; receiving a data packet in at least one of uplink and downlink direction; determining whether for the received data packet any service policy rules to be used for routing a service data flow to and within at least one external service function or at least one external service function chain are present; in case service policy rules to be used for routing a service data flow to and within at least one external service function or at least one external service function chain are present, applying the service policy rules to introducing routing information including a marking in the data packet, wherein the marking indicates service functions or service function chains to be used for the data packet; and routing the data packet including the routing information via relevant external service functions or external service function chains.

According to further refinements, these examples may include one or more of the following features:
information enabling a routing of data packets via at least one external service function or at least one external service function chain may be received, the information including at least one tag or identification element of a respective external service function or external service function chain, wherein the marking of the data packet may include an insertion of at least one of the received tag or identification element of a respective external service function or external service function chain;
the received service policy rules to be used for routing the service data flow to and within at least one external service function or at least one external service function chain may include at least one of generic service policy rules and specific policy rules being specific to an attached communication element or user, wherein the generic service policy rules or the specific service policy rules may indicate the routing information;
routing of later data packets of the same service data flow like the received data packet via the relevant external service function or external service function chain may be prepared;
an acknowledgement for the routing information from an external service function providing side may be received and processed, and introducing of the routing information in later data packets of the same service data flow may be omitted;
a data packet in one of an uplink direction and a downlink direction may be received, and transmission of the received data packet to a destination may be caused;
the above defined processing may be implemented in a communication network control element configured to act as at least one of a packet data gateway, traffic detection function and classifier element, which is connectable to an external service providing side by means of an interface.

In addition, according to embodiments, there is provided, for example, a computer program product for a computer, including software code portions for performing the steps of the above defined methods, when said product is run on the computer. The computer program product may include a computer-readable medium on which said software code portions are stored. Furthermore, the computer program product may be directly loadable into the internal memory of the computer and/or transmittable via a network by means of at least one of upload, download and push procedures.

### BRIEF DESCRIPTION OF THE DRAWINGS

Some embodiments of the present invention are described below, by way of example only, with reference to the accompanying drawings, in which:

FIG. 1 shows a diagram illustrating a general architecture of a communication system where some examples of embodiments are implementable;

FIG. 2 shows a signaling diagram illustrating a processing according to some examples of embodiments;

FIG. 3 shows a signaling diagram illustrating a processing according to some examples of embodiments;

FIG. 4 shows a signaling diagram illustrating a processing according to some examples of embodiments;

FIG. 5 shows a flow chart of a processing conducted in a service selection control function according to some examples of embodiments;

FIG. 6 shows a flow chart of a processing conducted in a control function on an external service function providing side according to some examples of embodiments;

FIG. 7 shows a flow chart of a processing conducted in a communication network control function according to some examples of embodiments;

FIG. 8 shows a diagram of a network element acting as a service selection control function according to some examples of embodiments;

FIG. 9 shows a diagram of a network element acting as a control function on an external service function providing side according to some examples of embodiments; and

FIG. 10 shows a diagram of a communication network control element according to some examples of embodiments.

### DESCRIPTION OF EMBODIMENTS

In the last years, an increasing extension of communication networks, e.g. of wire based communication networks, such as the Integrated Services Digital Network (ISDN), DSL, or wireless communication networks, such as the cdma2000 (code division multiple access) system, cellular 3rd generation (3G) like the Universal Mobile Telecommunications System (UMTS), and fourth generation (4G) communication networks or enhanced communication networks based e.g. on LTE or LTE-A, cellular 2nd generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the 3rd Generation Partnership Project (3GPP), Telecoms & Internet converged Services & Protocols for Advanced Networks (TISPAN), the International Telecommunication Union (ITU), 3rd Generation Partnership Project 2 (3GPP2), Internet Engineering Task Force (IETF), the IEEE (Institute of Electrical and Electronics Engineers), the WiMAX Forum and the like are working on standards or specifications for telecommunication network and access environments.

Embodiments as well as principles described below are applicable to any network element, relay node, server, node, corresponding component, and/or to any communication system or any combination of different communication systems that support required functionalities. The communication system may be a fixed communication system, a wireless communication system or a communication system utilizing both fixed networks and wireless networks. The protocols used, the specifications of communication systems, apparatuses, such as nodes, servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on 3GPP standards, such as a third generation or fourth generation (like LTE or LTE-A) communication network, without restricting the embodiments to such an architecture, however. It is obvious for a person skilled in the art that the embodiments may also be applied to other kinds of communications networks having suitable means by adjusting parameters and procedures appropriately, e.g. WLAN or WiFi, worldwide interoperability for microwave access (WiMAX), Bluetooth®, personal communications services (PCS), ZigBee®, wideband code division multiple access (WCDMA), systems using ultra-wideband (UWB) technology, sensor networks, and mobile ad-hoc networks (MANETs).

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules etc. that have not been specifically mentioned.

A basic system architecture of a communication system where examples of embodiments are applicable may include an architecture of one or more communication networks including a wired or wireless access network subsystem and a core network. Such an architecture may include one or more communication network control elements, access network elements, radio access network elements, access service network gateways or base transceiver stations, such as a base station (BS), an access point or an eNB, which control a respective coverage area or cell(s) and with which one or more communication elements, user devices or terminal devices, such as a UE, or another device having a similar function, such as a modem chipset, a chip, a module etc., which can also be part of an element, function or application capable of conducting a communication, such as a UE, an element or function usable in a machine to machine or D2D communication architecture, or attached as a separate element to such an element, function or application capable of conducting a communication, or the like, are capable to communicate via one or more channels for transmitting several types of data. Furthermore, core network elements such as gateway network elements, policy and charging control network elements, mobility management entities, operation and maintenance elements, and the like may be included.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication to or from an element, function or application, like a communication element, such as a UE, a communication network control element, such as an eNB, and a communication network besides those described in detail herein below.

A communication network may also be able to communicate with other networks, such as a public switched telephone network or the Internet. The communication network may also be able to support the usage of cloud services. It should be appreciated that network elements of an access system, of a core network etc., and/or respective functionalities may be implemented by using any node, host, server or access node etc. entity suitable for such a usage.

Furthermore, the described network elements, such as communication elements, like a UE, communication network control elements, access network elements etc., like an eNB, core network elements, like an MME etc., as well as corresponding functions as described herein, and other elements, functions or applications may be implemented by software, e.g. by a computer program product for a computer, and/or by hardware. For executing their respective functions, correspondingly used devices, nodes or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors.

It should be appreciated that according to some examples, a so-called “liquid” or flexible network concept may be employed where the operations and functionalities of a communication network element, network function, or of another entity of the communication network, such as of one or more of radio access network elements like an eNB, may be performed in different entities or functions, such as in a node, host or server, in a flexible manner. In other words, a “division of labor” between involved network elements, functions or entities may vary case by case.

An important aspect in the control of communication networks is related to service function and service function chaining. In this context, one target is to achieve a so-called flexible mobile service steering (FMSS).

The delivery of end-to-end services often require various service functions (SF) including e.g. traditional network service functions as well as application-specific features.

A service function concerns, for example, a function that is responsible for specific treatment of (received) packets. For example, a service function may act at a network layer or other OSI layers, can be a virtual instance or be embedded in a physical network element, wherein one of multiple service functions may be embedded in the same network element. It is also possible that multiple instances of a service function are enabled in the same administrative domain. Examples of service functions concern, for example, firewalls, network and application acceleration, deep packet inspection, server load balancers, optimizers, etc.

Service function chaining is used to describe an ordered set of such service functions, and the subsequent “steering” of traffic flows, such as SDF, through those service functions. That is, a service function chain defines an ordered set of service functions that has to be applied to packets and/or frames selected as a result of classification. Service function chaining in communication networks, such as 3GPP based networks, is assumed to be standardized and/or implemented at certain interfaces of the network, such as a so-called Gi/SGi reference point, so that a communication network control element of the core network of the communication network, such as a P-GW, a GGSN etc., can be involved in the processing. For example, the P-GW or GGSN is configured to provide some services and to modify data packets or an SDF in a manner like an external service function in a service chain. According to further examples, it is also possible that external functions could be replaced by services of the P-GW or GGSN. For example, the communication network control element of the core network of the communication network, such as the P-GW, may include a packet classifier function (or functions) allowing to classify IP packets for routing within the service function chain. It is also assumed that service functions of the chain beyond the Gi/SGi reference point are not in accordance with specifications of the communication network, i.e. may be part of a foreign external network.

Communication networks, such as a 3GPP based system, have unique core assets, denoted as service capabilities, such as communications, context, subscription and control, that may be valuable to application providers. Communications refers to functions like voice calling, SMS, MMS, web browsing, streaming, etc.. Subscription includes, for example, subscription identity, feature sets, preference. Context covers real-time user information such as location, presence, profile, device capabilities and data connection type. Control addresses functions like Quality of Service, policy and security.

Network operators may offer value added services by exposing these service capabilities to external application providers, businesses and partners using a suitable interface, such as a web based API. In addition, network operators may combine other internal or external services with their network capabilities to provide richer, composite API services to their partners. Thus, mobile network intelligence can be brought to applications.

Service capability exposure includes the identification and definition of service capabilities on the one hand and the exposure of the capabilities on the other hand. By means of service capability exposure, it is possible to provide authorized and secure access to service capabilities of the communication network and execution of services.

In order to expose service capabilities, for example, a concept referred to as AESE may be used by means of which communication network provided service capabilities are exposed to application providers, e.g. via OMA-API(s), allowing the API and the communication network, such as a 3GPP system, to act together to expose communication network service capabilities.

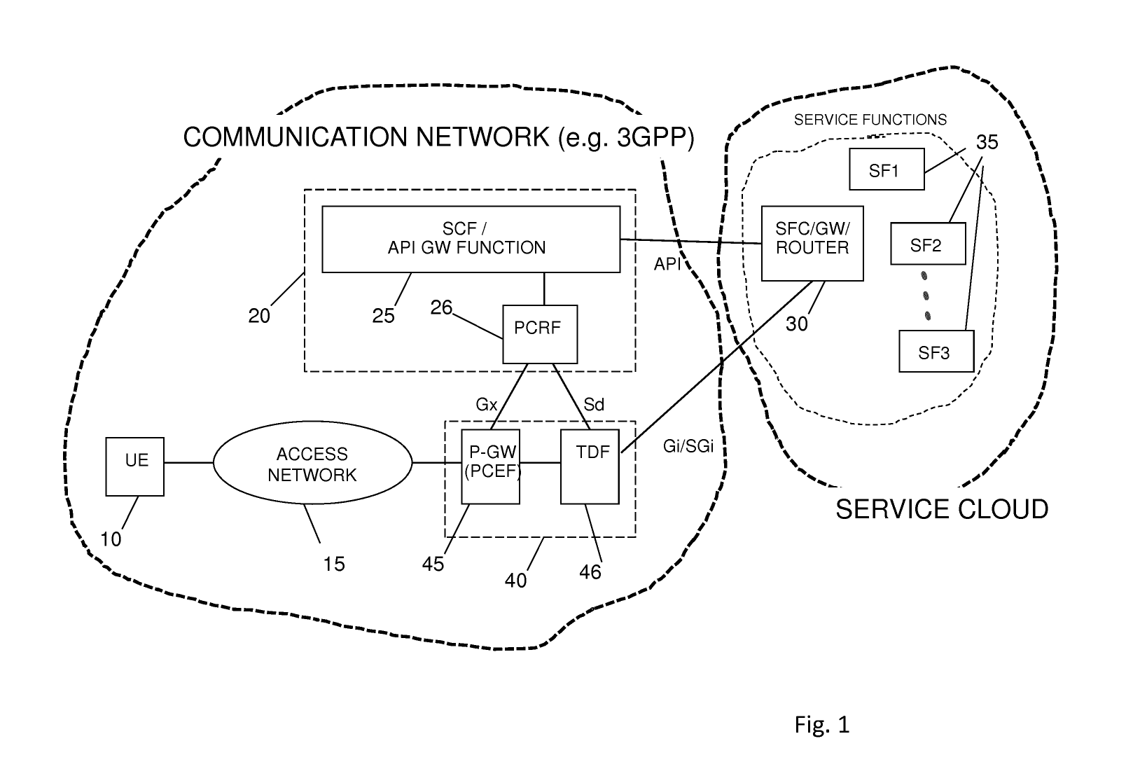

With regard to FIG. 1, a diagram illustrating a general architecture of a communication system is shown where some examples of embodiments are implementable. It is to be noted that the structure indicated in FIG. 1 shows only those devices, network elements and links which are useful for understanding principles underlying the examples of embodiments of the invention. As also known by those skilled in the art there may be several other network elements or devices involved in a communication in the communication system which are omitted here for the sake of simplicity.

In FIG. 1, two networks are shown which form the general basis of the example of a communication system according to some examples of embodiments. Specifically, as a first network, a (wireless) communication network based for example on a 3GPP specification is provided, while as a second network an external service providing network or system, such as a service cloud, is provided. It is to be noted that both the number of networks as well as the type thereof as depicted in FIG. 1 are merely intended to provide a basis for illustrating the principles of the control processing according to some examples of embodiments, while each one of the number and type of the involved network may be different to those shown in FIG. 1.

According to FIG. 1, reference sign 10 denotes a communication element, such as a UE, of a subscriber which represents one terminal point of a communication, i.e. from which UL data packets are transmitted and to which DL data packets are sent. Reference sign 15 denotes an access network via which the UE 10 is connecting to the communication network. The access network comprises, for example, base stations, access nodes or the like.

Reference sign 40 denotes a communication network control element of a core network of the communication network, which comprises a gateway function acting as a gateway to an external side, such as a P-GW 45, and a traffic detection function (TDF) 46. It is to be noted that the TDF may be a standalone unit (in which case a separate interface, such as an Sd interface or reference point, is provided to a policy and charging rules function (to be described later)), or may be collocated as an ADC with a PCEF in the P-GW 45. PCEF 45 and TDF 46 are configured to fulfill several functions, such as traffic detection for identifying and measuring (Internet) data traffic, including over-the-top services, policy enforcement for applying direct and indirect management to ensure optimal traffic flow, and charging enforcement.

Reference sign 20 denotes a service selection control and policy and charging rules element or function. For example, an SCF/API GW function 25 and PCRF 26 are implemented for executing a corresponding processing (referred to hereinafter also as SCF/PCRF 20). In this context, the API-GW function 25 is configured, for example, to hosts API framework functions, like providing the API(s) with secured, authenticated and authorized access to capabilities offered by the 3GPP system. The PCRF 26 represents, for example, an entity used for policy and QoS control for a converged network by 3GPP.

For connecting the communication network control element 40 and the SCR/PCRF 20, corresponding reference points or interfaces are to be provided. For example, as shown in the 3GPP system depicted in FIG. 1, a Gx interface is provided for transferring (QoS) policy and charging rules from PCRF to the PCEF in the P-GW 45. Furthermore, as indicated above, in case the TDF 46 is a standalone entity, an Sd interface is used between the TDF 46 and the PCRF 26.

On the external service providing side, such as in a service cloud providing such service functions or service function chains, reference sign 30 denotes an external-service providing control element including, for example, gateway (GW) functions, router functions and the like (referred to hereinafter also as SFC/GW/router 30). For example, the SFC/GW/router 30 is configured to manage and control respective service functions 31 in the service cloud, to receive and process service requests and data packets related to one or more service functions 31 (or service function chains), and to transmit information, responses, data packets etc. to the communication network. According to examples of embodiments, as interfaces between the SFC/GW/router 30 and the communication network, a management interface, such as an API interface, is established to and from the SCR/PCRF 20. Furthermore, a Gi/SGi reference point is used between the communication network control element 40 (e.g. P-GW or GGSN). Gi/SGi represents the reference point between a GGSN or P-GW and a packet data network, such as an operator external public or private packet data network or an intra operator packet data network.

It is to be noted that even though FIG. 1 shows only one SFC/GW/router functionality controlling a service function chain, it is obvious that also other configurations are feasible.

For example, a central controller being in charge of multiple chains is conceivable which may also advertise (as described below) corresponding service function chains, their services and their parameters. Also a plurality of external service clouds or the like may be provided so as to be accessible by the communication network instead of only one as depicted in FIG. 1.

According to examples of embodiments of the invention, an architecture, control procedures and protocols will be described in the following allowing a control of a communication using service function chaining.

Specifically, according to examples of embodiments, concepts are provided allowing the usage of external service functions or external service function chains by a communication network, such as a 3GPP based network, by using specific interfaces, such as a Gi/SGi reference point. That is, examples of embodiments of the invention provide a solution allowing a communication network, such as a 3GPP based network, to manage and access e.g. a Gi/SGi external service function chain. Furthermore, a mechanism for the communication network is provided so as to know which services are available at an external service providing side, i.e. in respective external service function chains. Also a generation and provision of service policy rules for service data flows is considered, and a mechanism for the communication network is provided in order to route classified SDFs via determined services as per relevant service policy rules.

According to examples of embodiments, it is suggested to implement principles of a mechanism to expose service capabilities of the external service providing side by means of suitable mechanisms, such as one being based on that the concept of AESE, in order to implement a service chaining procedure that is configured, for example, to support Gi/SGi external service functions. For example, according to some examples of embodiments, a management interface is established between the 3GPP network and the external service function chain.

There are several possibilities for achieving a corresponding control procedure.

For example, according to an example of embodiments, the external-service providing side, e.g. a controller function thereof like the SFC/GW/router 30, uses suitable interfaces towards the communication network, for example an API or a Gi/SGi reference point, for advertising or offering available service functions or service function chains (i.e. SF 31), and their capabilities to the communication network side, where a service capability function like the SCF 25 processes the indicated service functions or service function chains. The SCF decides, for example, to use, or subscribe to, one or more of the indicated service function chains and/or one or more of the indicated service functions and possibly their selected capabilities. In this way, it is possible that the communication network is able to use also its own (internal) service functions when ever available or appropriate, while a complementation of the (own) services with the advertised external service functions is also possible.

Alternatively or additionally, the communication network side knows about the availability of service function chains and/or service functions and/or the features of service functions by other sources, e.g. by pre-configuration or through an enquiry from a third entity. In other words, according to examples of embodiments, indicating (e.g. by storing or advertising information) of service functions or service function chains does not necessarily require a signaling of corresponding data from an external service function providing side (e.g. a service cloud or the like); corresponding data can also be indicated and hence received or acquired from another source (third party) or received and stored in a configuration process.

According to examples of embodiments, the SCF and/or PCRF (as separate functions or as an integrated function) is/are configured to acquire service policy rules for service data flows (SDF). Service policy rules being acquired by the SCF/PCRF 20 include, for example, generic service policy rules and/or specific service policy rules. For example, the policy rules include a number of parameters with values or value ranges. For example, according to examples of embodiments, the SCF/PCRF 20 is configured to access to a subscription profile of a user/subscriber, for example by referring to any of SPR/UDR/HSS. Relevant content thereof is then used as input information for the creation/generation of user/UE related service policy rules (also referred to as specific service policy rules).

According to examples of embodiments, generic service policy rules being acquired by the SCF/PCRF 20 include, for example, rules being statically set, i.e. which are valid until the generic service policy rules are made invalid. Alternatively or additionally, at least a part of the generic service policy rules can be dynamically changeable. That is, dynamically changeable generic service policy rules can be changed or updated in accordance with an occurrence of specific events, for example, when a certain time of a day is reached (e.g. at night time), or at specific days (e.g. during weekend, on holidays) etc..

According to further examples of embodiments, service policy rules are acquired when the SCF/PCRF 20 detects that a certain triggering event happens.

For example, an event triggering an activation of (specific) service policy rules (which may be specific to a UE or subscriber/user) and hence that the corresponding service policy rules are to be acquired, may include one of the following: an attachment of a UE or subscriber/user to the communication network, an initiation of an application requiring a SDF, an activation of a service, an update of a UE or subscriber/user profile/data, a specified time point (e.g. a certain daytime or a certain date), an elapse of a specified period of time (e.g. time elapsed after a first initiation of a service usage), a traffic load situation (congestion level in the communication network), a change of a location of the UE or subscriber/user (e.g. entry into the home network area of the UE or subscriber/user), etc.

Moreover, according to some examples of embodiments, the service policy rules may be acquired in different ways. For example, (specific) service policy rules can be generated by the SCF/PCRF 20, for example, when a requirement for service policy rules is determined (e.g. due to the detection of a triggering event or the like). Alternatively or additionally, pre-stored information indicating the specific service policy rules may be used. For example, “dormant” service policy rules being pre-stored in the network (e.g. a home subscriber server or the like) can be acquired by activating these “dormant” rules when required.

Furthermore, according to examples of embodiments, in case a communication element such as a UE attaches to the communication network via a corresponding access network, the SCF/PCRF 20 is configured to send relevant service policy rules to the communication network element, such as a corresponding P-GW/TDF, being in charge for the attached UE.

According to further examples of embodiments, service policy rules, but also subscriptions to service functions or service function chains, are updated to new settings or configurations. For example, the update is executed in response to an indication from the external service function providing side. Alternative, also the communication network may trigger a corresponding update.

For example, when considering the above described example in a configuration like that shown in FIG. 1, the Gi/SGi user plane reference point may be used for routing given or classified SDFs via determined service functions. When the P-GW/TDF 40 detects an (application) data packet, e.g. a data packet being related to a start of an application, it is checked whether there are service policy rules for the detected application or the SDF thereof. In case a corresponding service policy rule is detected, the P-GW/TDF 40 is configured to mark the data packet in question accordingly so as to enable routing thereof via the relevant external service function or external service function chain.

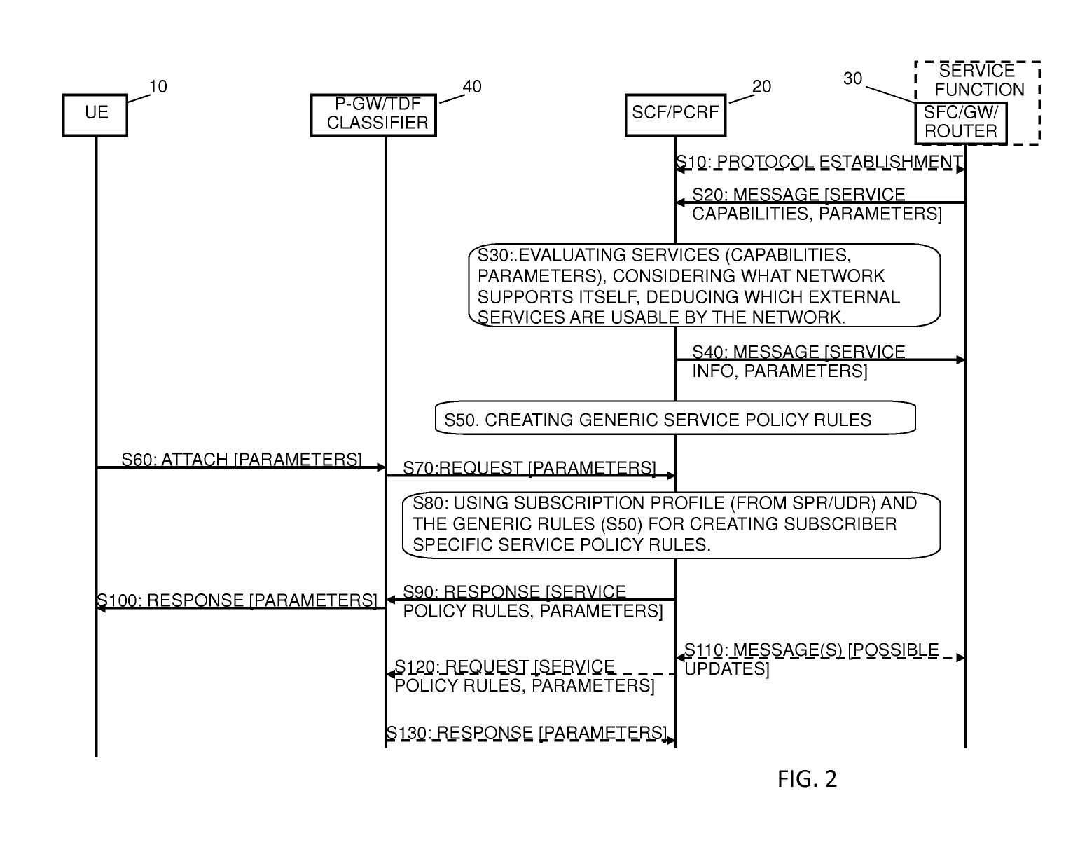

In the following, referring to FIGS. 2 to 4, operations of the communication system being based, for example, in the above described examples of embodiments are discussed in further detail.

FIG. 2 shows a signaling diagram illustrating a corresponding control processing according to some examples of embodiments which correspond to the above described procedure. Specifically, FIG. 2 is related to a processing according to the above described example wherein a service function advertisement and a corresponding policy creation are conducted. It is to be noted that the signaling partners indicated in FIG. 2 are related, for example, to the elements shown in FIG. 1.

In S10, a control protocol is established between the external service function chain or chains (e.g. the SFC/GW/router 30) and the 3GPP network via a specific interface, for example over the Gi/SGi reference point.

In S20, the SFC/GW/router 30 advertises for the service function chain available service functions, wherein according to examples of embodiments also their capabilities can be indicated. As additional parameters, an indication of one or more tags or IDs can be included which can be used for identifying corresponding service functions for SDFs (i.e. when SDFs are routed via the relevant service function chain, as described below).

It is to be noted that according to some examples of embodiments, the indication of one or more tags or IDs includes, for example, the tags or ID elements as such; alternatively or additionally, also other information, for example, an index number or the like, from which a corresponding tag or ID can be deduced, can be used as an indication of one or more tags or IDs.

In S30, the SCF/PCRF 20 conducts a processing in which it evaluates the offered service capabilities and related parameters. In addition, in the processing of S30, it is also considered what the 3GPP network supports itself (e.g. own service functions of the communication network). Then, it deduces which of the offered services/service functions are usable by the communication network.

In S40, the SCF/PCRF 20 sends a response to the SFC/GW/router 30 of the service function chain. The response indicates, for example, those service functions (and possibly their capabilities) which the communication network intends to use and/or intends to subscribe to.

It is to be noted that the above described processing reflects only those examples of embodiments which are related to an advertising of data for informing about the available service functions or service function chains at the external service function providing side. Alternatively, corresponding information may be present at the SCF/PCRF side by means of other ways, e.g. information being pre-stored (e.g. in connection with configuration data) or from a third entity.

In S50, the SCF/PCRF 20 creates, for example, generic service policy rules for the services/service functions. According to examples of embodiments, such a generic service policy rule includes a number of parameters with values or value ranges. When the values/value ranges are met in conjunction with a detected user data packet, the packet is assumed to be related to the corresponding service policy rule and will hence be routed to the related (external) service/service function. Generic service policy rules may be, according to examples of embodiments, static and/or dynamically changeable.

In S60, it is assumed that a communication element, such as the UE 10, attaches to the communication network via an access network subsystem, for example (see FIG. 1).

In S70, the P-GW 40 as the core network control element being related to the attached UE 10 sends an authorization request to the PCRF.

In S80, the SCF/PCRF 20 generates subscriber specific service policy rules, wherein it may use, for example, information derived from a subscription profile of the UE 10 (derived e.g. from corresponding SPR/UDR) and the generic service policy rules (as created in S50). That is, according to this example, as a trigger event, an attachment of UE 10 is assumed, while other trigger events as discussed above may also be possible. Moreover, it is to be noted that in case the SCF function 25 and the PCRF function 26 are not integrated/collocated in one element or function 20, the PCRF function 26 is configured to communicate with the SCF function 25 or a related database (not shown) in order to obtain the generic service policy rules related to services allowed for the subscriber of UE 10.

In S90, the SCR/PCRF 20 sends a response to the P-GW 40. The response contains, for example, the service policy rules to be used for routing SDFs to and within the service function chain, when the P-GW 40 (e.g. ADC) detects a related (application) data packet. According to some examples of embodiments, the response in S90 includes also tags/IDs of service functions in order to enable the routing of application data packets/SDFs within the service function chain (the tags/IDs obtained in S20, for example).

It is to be noted that in case the network architecture relates a standalone TDF 46 (instead of ADC in P-GW, for example), the SCF/PCRF 20 may be configured to send a message with a corresponding content (policy rules, tags, etc.) to the TDF 46.

In S100, the P-GW 40 sends a response towards the UE 10.

According to examples of embodiments, as indicated above, it is possible that updates are required, e.g. in response to an indication from the communication network or from the external service function providing side. In the example of FIG. 2, for example, it is assumed that the updates are required for a status of available service functions, capabilities thereof, parameters, subscription data etc. related to the external service functions or external service functions chains. In such a case, for example, as indicated in S110, the service function providing side (e.g. the SFC/GW/router 30) indicates the necessity of such an update e.g. of the status of the available service functions and/or their capabilities or parameters to the communication network. The SCF/PCRF 20 conducts then a processing in order to update its subscription to the services advertised by the external service cloud. Examples for a necessity of an update are, for example, an unavailability or congestion or re-availability of corresponding services in the communication network, an increase or a reduction of service function resources, e.g. by means of increasing or reducing the number of available service function instances or VNFs in order to adapt the available resources to a load status of the (virtual network).

In S120, the SCF/PCRF 20 updates corresponding service policy rules and informs the P-GW/TDF 40.

In S130, a response from the P-GW/TDF is sent to the SCF/PCRF 20.

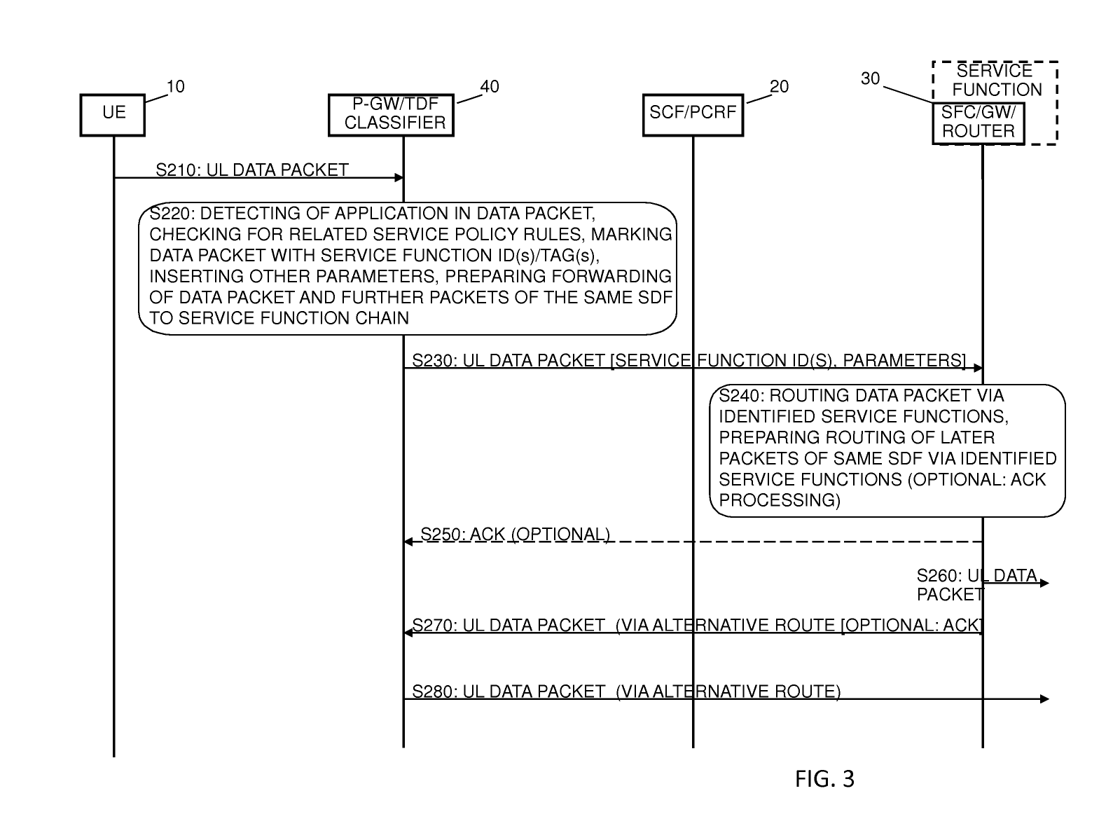

Next, with regard to FIG. 3, a signaling diagram illustrating a control processing according to some examples of embodiments which correspond to the above described procedure is shown. Specifically, FIG. 3 is related to a processing where an UL traffic detection and routing is explained. It is to be noted that the signaling partners indicated in FIG. 3 are also related, for example, to the elements shown in FIG. 1.

In S210, the P-GW/TDF 40 (which is provided, for example, with a packet classifier function) receives an UL data packet from the UE 10.

In S220, the P-GW/TDF (classifier) 40 conducts a processing for detecting an application in the received UL data packet and for checking (when the application in the received UL data packet is detected) whether there is /are service policy rule/rules available to this UE 10 (i.e. subscriber specific) or the SDF of the UL data packet. If the presence of corresponding rules is detected, the P-GW/TDF (i.e. the classifier) 40 marks the data packet with corresponding service function ID(s)/tag(s) and inserts possible other parameters (i.e. adds routing information). Then, the P-GW/TDF 40 prepares to forward the data packet as well as further data packets of the same SDF to the relevant service functions of the service function chain.

In S230, the P-GW/TDF/classifier 40 forwards the data packet to the service function chain (i.e. the SFC/GW/router 30), wherein the data packet is marked, as discussed in S220, with tag(s)/ID(s). According to some examples, the data packet may also contain further parameters.

In S240, the SFC/GW/router 30 of the service function chain conducts a processing for routing the data packet via the identified service functions. According to further examples, in case an acknowledgement procedure as described below is part of the operation, also preparations to route later packets of the same SDF via the identified service functions are made.

Specifically, according to examples of embodiments, the SCF/GW/router 30 conducts a processing in which an acknowledgement is prepared to be sent to the communication network. The reason is to enable the communication network (by P-GW/TDF/classifier 40) to omit the routing information, e.g. to drop service function IDs/tags and parameters, from later data packets of the same SDF. Then, in S250, the SCF/GW/router 30 of the service function chain sends a corresponding acknowledgement to the P-GW/TDF 40 to enable that further packets of the same SDF(s) are sent without the routing related tags/IDs and/or additional parameters.

It is to be noted that the alternative including the provision of the acknowledgement means that an SDF becomes stateful (i.e. a stateful operation is conducted) and that the state established after the detection of the start of an application is to be removed after the detection of the stop of the application. That means, for example, that the P-GW/TDF 40 sends a message/packet to the service function chain (i.e. the SCF/GW/router 30) for removing the state when the application is stopped.

As another alternative, the processing related to the acknowledgement is omitted, i.e. no acknowledgement is sent in S250. Then, the data packets to be routed via the service function chain always include the routing information such as the tags/IDs and/or additional parameters. This means that a stateless operation is possible.

In S260, the SCF/GW/router 30 causes a transmission of the UL data packet towards its destination.

As an alternative to S260, it is also possible that the UL data packet is transmitted to its destination via the communication network. In this case, the SCF/GW/router 30 routes the data packet back to P-GW/TDF 40 in S270.

Then, P-GW/TDF 40 forwards the UL data packet towards its destination in S280.

It is to be noted that also in case of a forwarding of the UL data packet to its destination by the communication network in S270 and S280, it is possible that an acknowledgement processing similar to that described in connection with S240 and S250 is conducted. That is, acknowledgement of routing information is applied to the message in S270 and processed by the P-GW/TDF 40. Then, when the UL data packet is forwarded to its destination in S280, acknowledgement parameter(s) being attached by the service function chain are of course dropped beforehand.

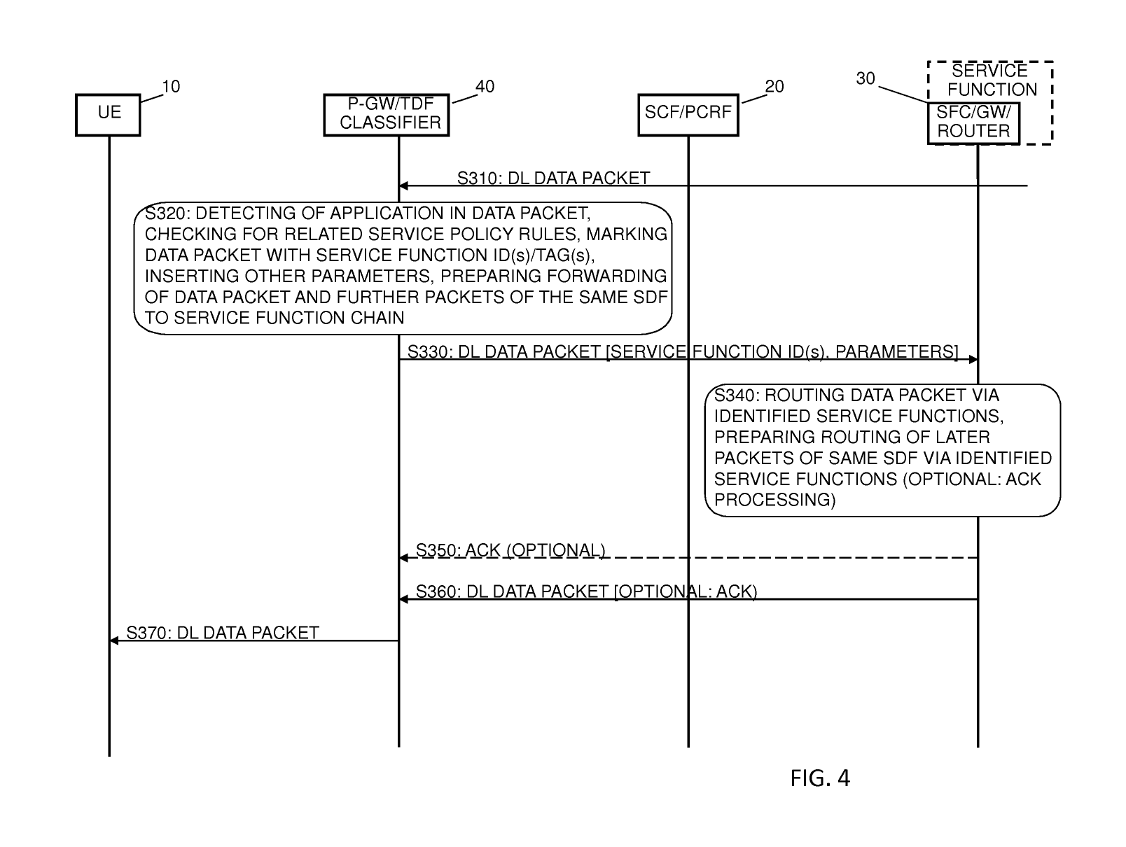

Next, with regard to FIG. 4, a signaling diagram illustrating a control processing according to some examples of embodiments which correspond to the above described procedure is shown. Specifically, FIG. 4 is related to a processing where a DL traffic detection and routing is explained. It is to be noted that the signaling partners indicated in FIG. 4 are also related, for example, to the elements shown in FIG. 1.

In S310, the P-GW/TDF 40 (e.g. provided with a packet classifier function) receives a DL data packet for UE 10.

In S320, the P-GW/TDF 40 conducts a processing for detecting an application in the received DL data packet and for checking (when the application in the received DL data packet is detected) whether there is/are service policy rule/rules available to the UE 10 (i.e. subscriber specific) or the SDF of the DL data packet. If the presence of corresponding rules is detected, the P-GW/TDF (i.e. the classifier) 40 marks the data packet with corresponding service function ID(s)/tag(s) and inserts possible other parameters (i.e. adds routing information). Then, the P-GW/TDF 40 prepares to forward the data packet as well as further data packets of the same SDF to the relevant service functions of the service function chain.

In S330, the P-GW/TDF/classifier 40 forwards the data packet to the service function chain (i.e. the SFC/GW/router 30), wherein the data packet is marked, as discussed in S320, with tag(s)/ID(s). According to some examples, the data packet may contain further parameters.

In S340, the SFC/GW/router 30 of the service function chain conducts a processing for routing the data packet via the identified service functions. According to further examples, in case an acknowledement procedure as described below is part of the operation, also preparations to route later packets of the same SDF via the identified service functions are made.

Specifically, according to examples of embodiments, the SCF/GW/router 30 conducts a processing in which an acknowledgement is prepared to be sent to the communication network. The reason is to enable the communication network (by P-GW/TDF/classifier 40) to omit the routing information, e.g. to drop service function IDs/tags and parameters, from later data packets of the same SDF. Then, in S350, the SCF/GW/router 30 of the service function chain sends a corresponding acknowledgement to the P-GW/TDF 40 to enable that further packets of the same SDF(s) are sent without the routing related tags/IDs and/or additional parameters.

It is to be noted that the alternative including the provision of the acknowledgement means that an SDF becomes stateful (or a stateful operation is conducted) and that the state established after the detection of the start of an application is to be removed after the detection of the stop of the application. That means, for example, that the P-GW/TDF 40 sends a message/packet to the service function chain (i.e. the SCF/GW/router 30) for removing the state when the application is stopped.

As another alternative, the processing related to the acknowledgement is omitted, i.e. no acknowledgement is sent in S350. Then, the data packets to be routed via the service function chain always include the routing information such as the tags/IDs and/or additional parameters. This means that a stateless operation is possible.

In S360, the SCF/GW/router 30 causes a transmission of the UL data packet towards its destination, i.e. the UE 10, via the communication network (i.e. via the P-GW/TDF 40).

As an alternative, it is also possible to add in the message sent in S360 an acknowledgement of routing information as described above, instead of using the message in S350.

Then, P-GW/TDF 40 forwards the DL data packet towards its destination, i.e. the UE 10, in S370. When an acknowledgement of routing information is applied to the message in S360, before forwarding the DL data packet to the UE 10 in S370, the acknowledgement parameter(s) being attached by the service function chain are of course dropped beforehand.

According to some further examples of embodiments, there are different ways to define and/or arrange the content and/or format of a communication between the communication network and the external service function chain.

For example, as a first option, it is possible to define or standardize the communication mechanism with containers or vendor specific definitions. In this case, a definition of detailed parameters, e.g. coding of services and service features and capabilities, is to be agreed, e.g. with service level agreements, between operators and service chain providers. For example, the parameters in S20 in FIG. 2 or in S230 and S330 in FIGS. 3 and 4 may just contain a list of simple parameters that can be interpreted by both sides based on a prior agreement.

As another option, it is possible to define or standardize generally known service functions and their features and capabilities in detail, in addition to defining the communication mechanism with containers or vendor specific definitions for further service functions and their possible features and capabilities. In this case, for example, the parameters in S20 in FIG. 2 or in S230 and S330 in FIGS. 3 and 4 may just contain a list of simple parameters that can be interpreted by both sides based on standards and/or on a prior agreement.

Moreover, as yet another option, it is possible to standardize parameters and coding for all service functions and for their features and capabilities to be used in the service function chain. In this case, for example, the parameters in S20 in FIG. 2 or in S230 and S330 in FIGS. 3 and 4 may just contain a list of simple parameters that can be interpreted by both sides based purely on standards.

It is to be noted that the first two options allow an easier and faster way to introduce new service functions, features and capabilities.

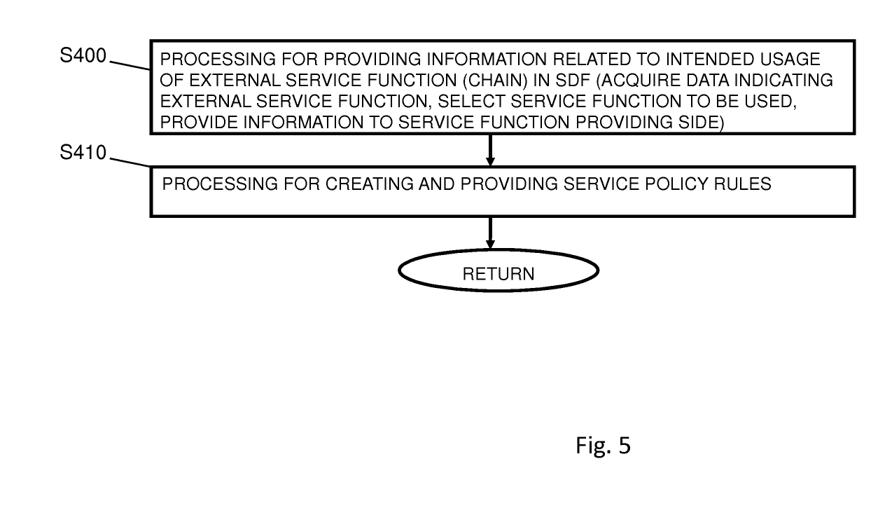

FIG. 5 shows a flow chart of a processing conducted in a service selection control function (and/or policy and charging rules function), such as the SCF/PCRF 20, according to some examples of embodiments. Specifically, the example according to FIG. 5 is related to a control procedure conducted by the communication element or node acting as a SCF/PCRF in the communication network as depicted e.g. in FIG. 1, which is connectable to an external service providing side (e.g. to SFC 30) by means of a suitable interface, such as API.

In S400, a processing is conducted which provides, to an external service function providing side, information being related to an intended usage of at least one external service function and/or at least one external service function chain in a SDF communicated in the communication network.

For example, according to one example of an embodiment, the processing in S400 includes to acquire, e.g. by means of receiving via a predetermined interface, data by means of which at least one available external service function and/or at least one available external service function chain is indicated. Then, it is decided whether at least one of the indicated external service functions or external service function chains is usable in a communication of a SDF in the communication network. Alternatively, the communication network side may know about the availability of service function chains and/or service functions and/or the features of service functions e.g. by configuration or through an enquiry from a third entity.

According to some examples of embodiments, the data indicating the available external service functions or external service function chains includes one or more of the following elements: an indication of a respective external service function or external service function chain, an indication of capabilities of a respective external service function or external service function chain, and an indication of a tag or ID element of a respective external service function or external service function chain.

Then, one or more of the indicated external service functions or external service function chains is/are selected for usage.

For example, according to examples of embodiments, the selection is based on the decision whether the indicated external service functions or external service function chains are usable in a communication of a SDF. In this context, the provided information related to the intended usage of at least one external service function or external service function chain reflects the selection result.

In this connection, according to some examples of embodiments, it is considered whether at least one own service function of the communication network may be used instead of an indicated external service function or external service function chain or, and whether the indicated external service function or external service function chain is applicable as a complement to an own service function of the communication network. According to the result of this consideration, i.e. a determination whether or not an own service is available or that external service functions can be used as complement to present service, the decision is made as to whether at least one of the indicated external service functions or external service function chains is usable in a communication of a service data flow.

In S410, a processing is conducted in which service policy rules are acquired, e.g. retrieved/generated/created, and provided.

For example, according to examples of embodiments, the processing in S410 includes to acquire generic service policy rules to be applied to a communication of a SDF in the communication network. The policy rules are to be used for routing a SDF to and within at least one external service function or external service function chain. A generic service policy rule may include, for example, a number of parameters with values or value ranges. When the values/value ranges are met in conjunction with a detected user data packet, the packet is assumed to be routed to the related service/service function. Furthermore, the generic service policy rules may include at least one of a static generic service policy rule part and a dynamically changeable generic service policy rule part, wherein the dynamically changeable generic service policy rule part is changeable with regard to an occurrence of a specific event, such as a certain daytime or the like.

Further in S410, a processing may be conducted in which specific service policy rules according to a subscriber are acquired, e.g. obtained or created, and provided. For example, according to an example of an embodiment, the processing in S410 includes a determination or detection that an event triggering an activation of specific service policy rules being specific to a UE or user occurred, and then to acquire the specific service policy rules whose activation is triggered. For example, an event triggering the activation of the specific service policy rules includes at least one of an attachment of a UE or user (like UE 10) to the communication network, an initiation of an application requiring a SDF, an activation of a service, an update of a subscription of a UE or user, a specified time point, an elapse of a specified period of time, a traffic load situation, a change of a location of the communication element or used, and the like. Furthermore, the acquiring of the specific service policy rules includes at least one of generating the specific service policy rules and obtaining pre-stored information indicating the specific service policy rules. Then, specific service policy rules corresponding to the communication element (e.g. UE 10) in question are created or retrieved, which are to be used for routing a SDF to and within at least one external service function or external service function chain.

The acquired (generated/created/retrieved) service policy rules are transmitted to a communication network control element (e.g. the P-GW/TDF 40) which is in charge of a UE for which a SDF is to be routed to the external service function providing side.

If necessary, according to some examples of embodiments, also an update of settings and parameters can be conducted, for example in response to a corresponding indication by the external service function providing side or by the communication network making such an update necessary. The updating concerns, for example, at least one of the generic policy rules, the specific policy rules, the service policy rules and the subscription to a service function or service function chain.

Then, the processing may return.

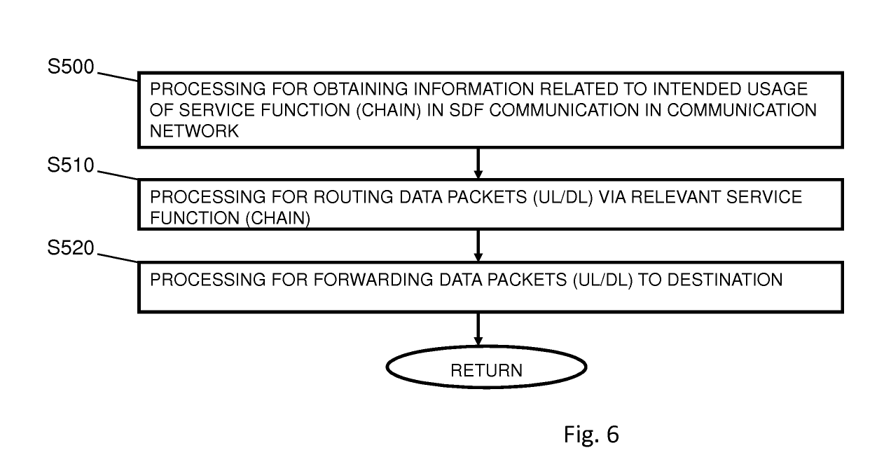

FIG. 6 shows a flow chart of a processing conducted in a control function on an external service function providing side, such as the SFC/GW/router 30, according to some examples of embodiments. Specifically, the example according to FIG. 6 is related to a control procedure conducted by the control element or node acting as a SFC/GW/router 30 in the service cloud as depicted e.g. in FIG. 1.

In S500, information is obtained from a communication network, which is related to an intended usage, by the communication network, of external service functions or external service function chains, which are assumed to be provided by the external service function providing side, in a SDF communicated in the communication network. The received information is processed in order to prepare external service functions or service function chains to be used in a communication of a service data flow. The information related to the intended usage of an external service function or external service function chain indicates a selection of one or more of the external service functions and/or one or more of the external service function chains.

For example, according to one example of an embodiment, the processing in S500 includes to provide, to the communication network, data advertising available external service functions or external service function chains via a predetermined interface. For example, the data are transmitted via a suitable interface to the communication network. Alternatively, the data may be provided by other means, e.g. in advance by informing a configuration instance or a third entity, so that the communication network side may know about the availability of service function chains and/or service functions and/or the features of service functions e.g. by configuration or through an enquiry from the third entity.

For example, the data indicating the available external service function or external service function chain includes at least one of the following elements: an indication of a respective external service function or external service function chain, an indication of capabilities of a respective external service function or external service function chain, and an indication of a tag or ID element of a respective external service function or external service function chain.

In S510, a processing for routing data packets via relevant service functions or service function chains is conducted. For example, when an UL data packet is received from the communication network, the received UL data packet is routed via identified service functions or service function chains. According to some examples of embodiments, the identification of the service functions or service function chains is based on an indication of routing information contained in the received UL data packet and including a marking, the marking indicating service functions or service function chains to be used for the data packet.

In S520, a processing for forwarding the data packet to a destination is conducted. For example, in case of an UL data packet, a transmission of the UL data packet to a destination in the UL direction is caused. Alternatively, the UL data packet is routed back to the communication network (e.g. the P-GW 40) for forwarding it from there to the destination thereof.

According to further examples of embodiments, an acknowledgement for the routing information is provided to the communication network. This acknowledgement is for enabling a drop of an introduction of routing information in later UL data packets of the same SDF (i.e. the stateful operation described above). In this case, a routing of later UL data packets of the same SDF like the received UL data packet via the identified service functions or service function chains is also prepared.

It is to be noted that the processing in S510 and S520 is applicable also in DL, i.e. the case of receiving a DL data packet from the communication network is similar.

That is, according to examples of embodiments, the received DL data packet is routed via identified service functions or service function chains, wherein the identification of the service function or service function chain is based on an indication of routing information contained in the received DL data packet.

Then, in S520, the DL data packet is forwarded back to the communication network for delivery to its destination.

Furthermore, similar to the UL case, also in the DL case an acknowledgement for the routing information may be provided to the communication network for enabling a drop of the indication of routing information in later DL data packets of the same SDF. In this case, routing of later DL data packets of the same SDF like the received DL data packet via the identified service function or service function chain is prepared.

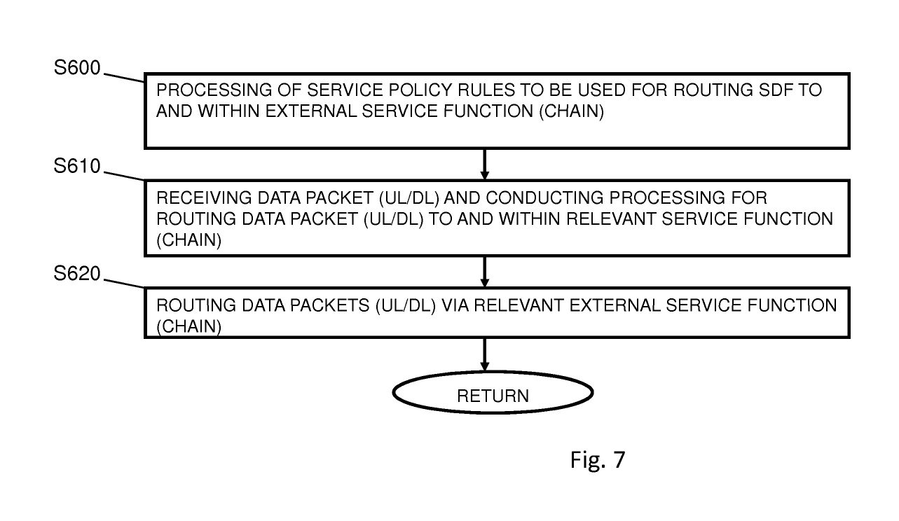

FIG. 7 shows a flow chart of a processing conducted in a communication network control function, such as the P-GW/TDF 40, according to some examples of embodiments. Specifically, the example according to FIG. 7 is related to a control procedure conducted by the communication network control element or node acting as a P-GW/TDF 40 in the communication network as depicted e.g. in FIG. 1.

In S600, service policy rules to be used for routing a SDF to and within external service functions or external service function chains are received and processed.

For example, the received service policy rules to be used for routing the SDF to and within at least one external service function or external service function chain include generic service policy rules and/or specific policy rules being specific to an attached communication element or user. The generic service policy rules and/or the specific service policy rules indicate routing information for the routing of the SDF.

In S610, a data packet (UL/DL) is received and a corresponding processing is conducted. That is, according to some examples of embodiments, it is determined whether for the received data packet any service policy rules to be used for routing a SDF to and within external service functions or external service function chains are present. If this is the case, i.e. there are service policy rules to be used for routing a SDF to and within external service functions or external service function chains are present, the service policy rules are applied to introducing the routing information which includes that the data packet is marked accordingly, wherein the marking indicates service functions or service function chains to be used for the data packet.

According to examples of embodiments, information enabling a routing of data packets via external service functions or external service function chains are received beforehand, wherein the information includes one or more of the following element: a tag or ID element of a respective external service function or external service function chain. In this case, the marking of the data packet includes an insertion of the tag or ID element of a respective external service function or external service function chain.

In S620, the marked data packet is routed via relevant external service functions or external service function chains.

According to further examples of embodiments, routing of later data packets of the same SDF like the received data packet via the relevant external service function or external service function chain is also prepared.

In addition, according to further examples of embodiments, it is possible that an acknowledgement for the routing information is received from an external service providing side, and processed accordingly. That is, when the acknowledgement is received, a marking of later data packets of the same SDF can be omitted, that is the indication of routing information therein is dropped.

It is to be noted that according to further examples of embodiments, after a data packed (UL/DL) is routed back from the external service functions or external service function chains, the data packet is transmitted to a destination (e.g. the UE 10 or a remote destination).

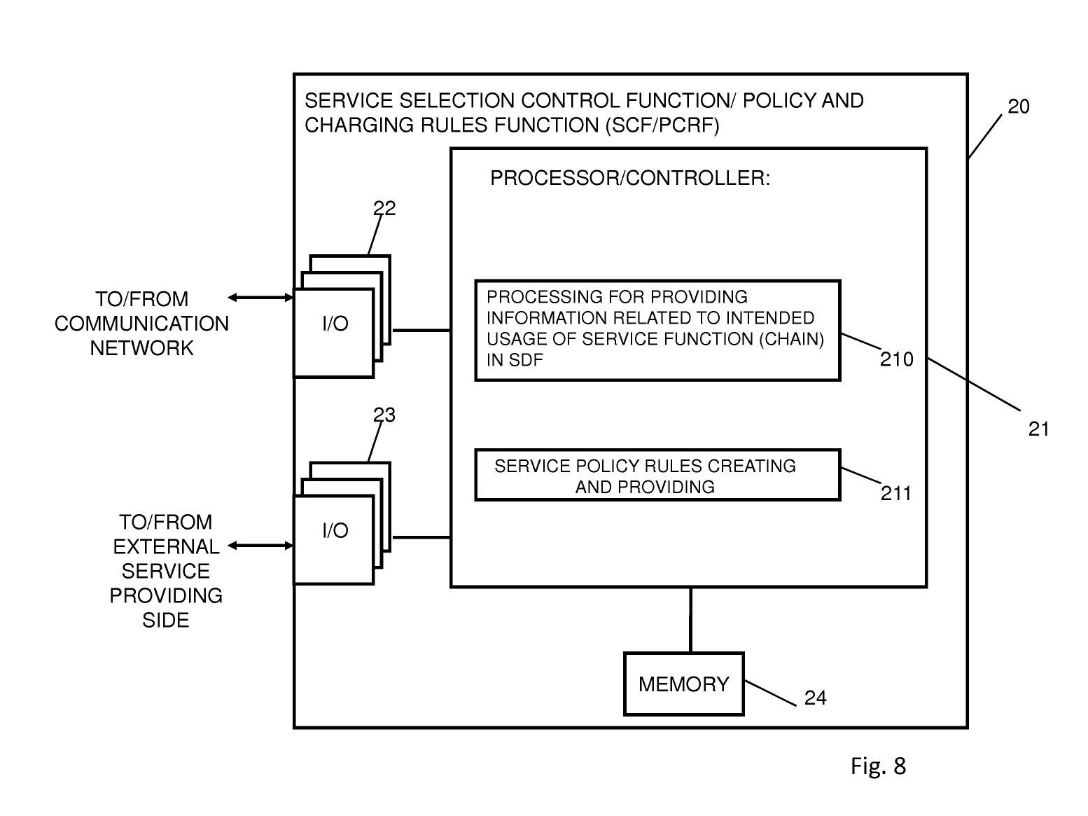

FIG. 8 shows a diagram of a network element acting as a service selection control function and policy and charging rules function according to some examples of embodiments, which is configured to implement a control procedure as described in connection with some of the examples of embodiments. It is to be noted that the network element, like the SCF/PCRF 20, which is shown in FIG. 8, may include further elements or functions besides those described herein below. Furthermore, even though reference is made to a network element or node, the element or node may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The network element shown in FIG. 8 may include a processing circuitry, a processing function, a control unit or a processor 21, such as a CPU or the like, which is suitable for executing instructions given by programs or the like related to the control procedure. The processor 21 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 22 and 23 denote transceiver or input/output (I/O) units or functions (interfaces) connected to the processor or processing function 21. The I/O units 22 may be used for communicating with a communication network, such as a core network element like the P-GW/TDF 40. The I/O units 23 may be used for communicating with an external service function providing side, such as the SFC/GW/router 30. The I/O units 22 and 23 may be a combined unit including communication equipment towards several network elements, or may include a distributed structure with a plurality of different interfaces for different network elements. Reference sign 24 denotes a memory usable, for example, for storing data and programs to be executed by the processor or processing function 21 and/or as a working storage of the processor or processing function 21. It is to be noted that the memory 24 may be implemented by using one or more memory portions of the same or different type of memory.

The processor or processing function 21 is configured to execute processing related to the above described control procedure. In particular, the processor or processing circuitry or function 21 includes one or more of the following sub-portions. Sub-portion 210 is a processing portion which is usable for providing information related to an intended usage of service functions or service functions chains in a SDF. The portion 210 may be configured to perform processing according to S400 of FIG. 5. Furthermore, the processor or processing circuitry or function 21 may include a sub-portion 211 usable as a portion for acquiring and providing service policy rules. The portion 211 may be configured to perform a processing according to S410 of FIG. 5.

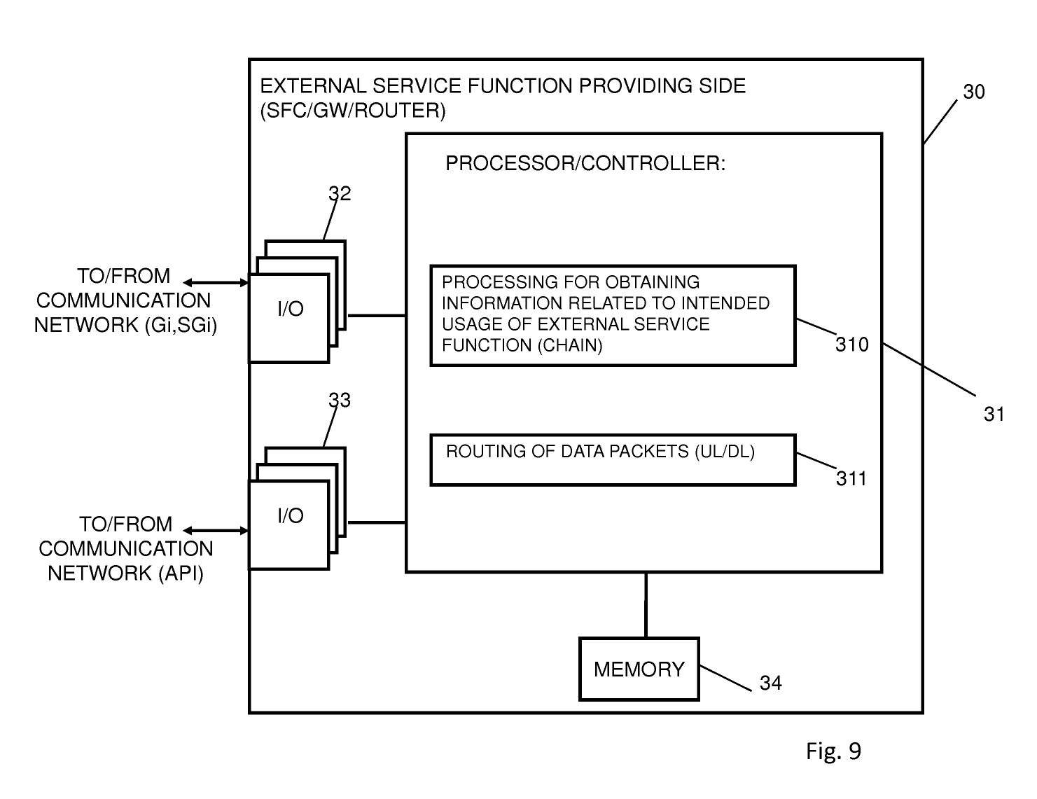

FIG. 9 shows a diagram of a network element acting as a control function on an external service function providing side according to some examples of embodiments, which is configured to implement a control procedure as described in connection with some of the examples of embodiments. It is to be noted that the network element, like the SFC/GW/router 30, which is shown in FIG. 9, may include further elements or functions besides those described herein below. Furthermore, even though reference is made to a network element or node, the element or node may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The network element shown in FIG. 9 may include a processing circuitry, a processing function, a control unit or a processor 31, such as a CPU or the like, which is suitable for executing instructions given by programs or the like related to the control procedure. The processor 31 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 32 and 33 denote transceiver or input/output (I/O) units or functions (interfaces) connected to the processor or processing function 31. The I/O units 32 may be used for communicating with a communication network, such as a core network element like the P-GW/TDF 40, for example by means of a Gi/SGi reference point. The I/O units 33 may be used for communicating with a communication network, such as a service selection control function like the SCF/PCRF 20. The I/O units 32 and 33 may be a combined unit including communication equipment towards several network elements, or may include a distributed structure with a plurality of different interfaces for different network elements. Reference sign 34 denotes a memory usable, for example, for storing data and programs to be executed by the processor or processing function 31 and/or as a working storage of the processor or processing function 31. It is to be noted that the memory 34 may be implemented by using one or more memory portions of the same or different type of memory.

The processor or processing function 31 is configured to execute processing related to the above described control procedure. In particular, the processor or processing circuitry or function 31 includes one or more of the following sub-portions. Sub-portion 310 is a processing portion which is usable for obtaining information related to an intended usage of service functions or service functions chains in a SDF. The portion 310 may be configured to perform processing according to S500 of FIG. 6. Furthermore, the processor or processing circuitry or function 31 may include a sub-portion 311 usable as a portion for routing data packets. The portion 311 may be configured to perform a processing according to S510 or S520 of FIG. 6.

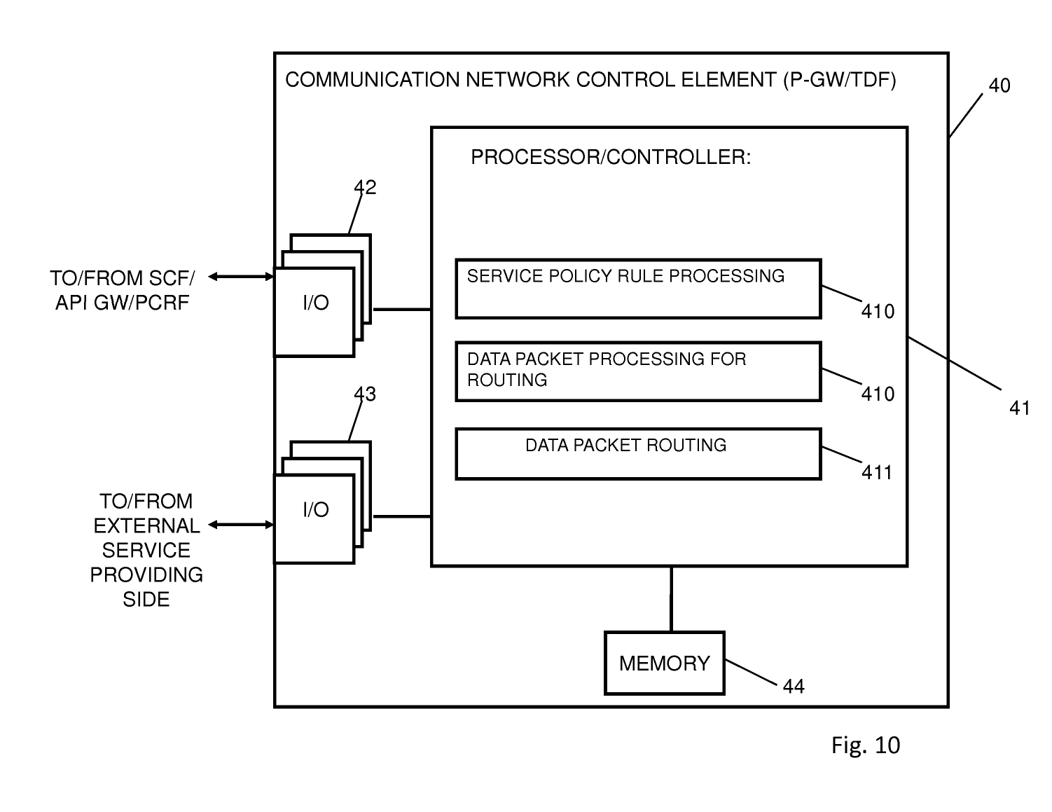

FIG. 10 shows a diagram of a communication network control element according to some examples of embodiments, which is configured to implement a control procedure as described in connection with some of the examples of embodiments. It is to be noted that the communication network control element, like the P-GW/TDF 40, which is shown in FIG. 10, may include further elements or functions besides those described herein below. Furthermore, even though reference is made to a communication network control element or node, the element or node may be also another device or function having a similar task, such as a chipset, a chip, a module, an application etc., which can also be part of a communication network control element or attached as a separate element to a communication network control element, or the like. It should be understood that each block and any combination thereof may be implemented by various means or their combinations, such as hardware, software, firmware, one or more processors and/or circuitry.

The communication network control element shown in FIG. 10 may include a processing circuitry, a processing function, a control unit or a processor 41, such as a CPU or the like, which is suitable for executing instructions given by programs or the like related to the control procedure. The processor 41 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 42 and 43 denote transceiver or input/output (I/O) units or functions (interfaces) connected to the processor or processing function 41. The I/O units 42 may be used for communicating with a service selection control function and policy and charging rules function, such as a the SCF/PCRF 20. The I/O units 43 may be used for communicating with an external service function providing side, such as the SFC/GW/router 30. The I/O units 42 and 43 may be a combined unit including communication equipment towards several network elements, or may include a distributed structure with a plurality of different interfaces for different network elements. Reference sign 44 denotes a memory usable, for example, for storing data and programs to be executed by the processor or processing function 41 and/or as a working storage of the processor or processing function 41. It is to be noted that the memory 44 may be implemented by using one or more memory portions of the same or different type of memory.

The processor or processing function 41 is configured to execute processing related to the above described control procedure. In particular, the processor or processing circuitry or function 41 includes one or more of the following sub-portions. Sub-portion 410 is a processing portion which is usable for processing service policy rules. The portion 410 may be configured to perform processing according to S600 of FIG. 7. Furthermore, the processor or processing circuitry or function 41 may include a sub-portion 411 usable as a portion for processing data packets for routing. The portion 411 may be configured to perform a processing according to S610 of FIG. 7. In addition, the processor or processing circuitry or function 41 may include a sub-portion 412 usable as a portion for routing data packets. The portion 412 may be configured to perform a processing according to S620 of FIG. 7.

By means of the measures described above, it is possible to offer operators an optimized way to support service function chaining. For example, when an architecture as described above is used, in which principles of an AESE architecture are considered, the need for different new entities and interfaces is minimized. Processings related to the described control scheme can be executed in elements, functions or nodes which basically correspond to the SCF/PCRF for policy creation and P-GW/TDF for traffic detection, classification and routing control, as described in examples of embodiments.

Furthermore, it is to be noted that according to some examples of embodiments, a stateless operation (i.e. without acknowledgement processing as e.g. in S250 and S350 in FIGS. 3 and 4) is less complex that a stateful operation, since an extra message exchange and state handling can be omitted. In such a case, for example, a parameter transfer can be based on a procedure using a NSH being added to encapsulated network packets or frames to create network service paths. In addition to path information, such a NSH may also carry metadata used by network devices and/or network services. Another alternative for parameter transfer is to use unused bits in a frame.

Furthermore, according to examples of embodiments, it is possible that the external service function chain is isolated from the communication network so that confidential issues of the communication network are not exposed to an external network (i.e. the service function chain provider).

As indicated above, some examples of embodiments may be applied to a partly or fully virtualized environment comprising one or more VNFs. In this case, some examples of embodiments enable a flexible scale-in and scale-out of resources, i.e. reducing or increasing the number of e.g. service function instances or VNFs in a service function chain, and accordingly updating the availability information towards the communication network (e.g. in S110 of FIG. 2).

According to another example of embodiments, there is provided an apparatus including means for acquiring data indicating at least one available external service function or at least one external service function chain via a predetermined interface, means for deciding whether at least one of the indicated at least one external service function or at least one external service function chain is usable in a communication of a service data flow in the communication network, means for selecting at least one from the indicated at least one external service function or at least one external service function chain for use on the basis of the decision whether at least one of the advertised at least one external service function or external service function chain is usable in a communication of a service data flow, and means for providing, to an external service function providing side, information related to an intended usage of at least one external service function or at least one external service function chain in a service data flow communicated in a communication network.

Furthermore, according to another example of embodiments, there is provided an apparatus including means for obtaining, from a communication network, information related to an intended usage, by the communication network, of at least one external service function or at least one external service function chain in a service data flow communicated in a communication network, and means for processing the information for preparation of the indicated at least one external service function or at least one service function chain for usage in a communication of a service data flow.

Furthermore, according to another example of embodiments, there is provided an apparatus including means for receiving and processing service policy rules to be used for routing a service data flow to and within at least one external service function or at least one external service function chain; means for receiving a data packet in at least one of uplink and downlink direction; means for determining whether for the received data packet any service policy rules to be used for routing a service data flow to and within at least one external service function or at least one external service function chain are present; means for applying, in case service policy rules to be used for routing a service data flow to and within at least one external service function or at least one external service function chain are present, the service policy rules to introducing routing information including a marking in the data packet, wherein the marking indicates service functions or service function chains to be used for the data packet; and means for routing the data packet including the routing information via relevant external service functions or external service function chains.

It should be appreciated that
an access technology via which signaling is transferred to and from a network element may be any suitable present or future technology, such as WLAN (Wireless Local Access Network), WiMAX (Worldwide Interoperability for Microwave Access), LTE, LTE-A, Bluetooth, Infrared, and the like may be used; additionally, embodiments may also apply wired technologies, e.g. IP based access technologies like cable networks or fixed lines.
a user device (also called UE, user equipment, user terminal, terminal device, etc.) illustrates one type of an apparatus to which resources on the air interface may be allocated and assigned, and thus any feature described herein with a user equipment may be implemented with a corresponding apparatus, such as a relay node. An example of such a relay node is a layer 3 relay (self-backhauling relay) towards a base station or eNB. The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network, or a nearly exclusive downlink only device, such as a portable video player. Also equipment used for measuring certain values, such as sensors which can measure a temperature, a pressure etc., can be used as a corresponding user device. It should be appreciated that a device may be regarded as an apparatus or as an assembly of more than one apparatus, whether functionally in cooperation with each other or functionally independently of each other but in a same device housing.
embodiments suitable to be implemented as software code or portions of it and being run using a processor or processing function are software code independent and can be specified using any known or future developed programming language, such as a high- level programming language, such as objective-C, C, C++, C#, Java, etc., or a low-level programming language, such as a machine language, or an assembler.
implementation of embodiments is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), and/or TTL (Transistor-Transistor Logic).
embodiments may be implemented as individual devices, apparatuses, units, means or functions, or in a distributed fashion, for example, one or more processors or processing functions may be used or shared in the processing, or one or more processing sections or processing portions may be used and shared in the processing, wherein one physical processor or more than one physical processor may be used for implementing one or more processing portions dedicated to specific processing as described,
an apparatus may be implemented by a semiconductor chip, a chipset, or a (hardware) module including such chip or chipset;
embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components.
embodiments may also be implemented as computer program products, including a computer usable medium having a computer readable program code embodied therein, the computer readable program code adapted to execute a process as described in embodiments, wherein the computer usable medium may be a non-transitory medium.
Although the present invention has been described herein before with reference to particular embodiments thereof, the present invention is not limited thereto and various modifications can be made thereto.

1.-42. (canceled)

43. An apparatus including
at least one processing circuitry, and
at least one memory for storing instructions to be executed by the processing circuitry, wherein
the at least one memory and the instructions are configured to, with the at least one processing circuitry, cause the apparatus at least:
to receive and process service policy rules to be used for routing a service data flow to and within at least one external service function or at least one external service function chain;
to receive a data packet in at least one of uplink and downlink direction;
to determine whether for the received data packet any service policy rules to be used for routing a service data flow to and within at least one external service function or at least one external service function chain are present;
in case service policy rules to be used for routing a service data flow to and within at least one external service function or at least one external service function chain are present, to apply the service policy rules to introducing routing information including a marking in the data packet, wherein the marking indicates service functions or service function chains to be used for the data packet; and
to route the data packet including the routing information via relevant external service functions or external service function chains.

44. The apparatus according to claim 43, wherein the at least one memory and the instructions are further configured to, with the at least one processing circuitry, cause the apparatus at least:
to receive information enabling a routing of data packets via at least one external service function or at least one external service function chain, the information including at least one tag or identification element of a respective external service function or external service function chain,
wherein the marking of the data packet includes an insertion of at least one of the received tag or identification element of a respective external service function or external service function chain.

45. The apparatus according to claim 43, wherein the received service policy rules to be used for routing the service data flow to and within at least one external service function or at least one external service function chain include at least one of generic service policy rules and specific policy rules being specific to an attached communication element or user, wherein the generic service policy rules or the specific service policy rules indicate the routing information.

46. The apparatus according to claim 43, wherein the at least one memory and the instructions are further configured to, with the at least one processing circuitry, cause the apparatus at least:
to prepare routing of later data packets of the same service data flow like the received data packet via the relevant external service function or external service function chain.

47. The apparatus according to claim 46, wherein the at least one memory and the instructions are further configured to, with the at least one processing circuitry, cause the apparatus at least:
to receive and process an acknowledgement for the routing information from an external service function providing side; and
to omit introducing of the routing information in later data packets of the same service data flow.

48. The apparatus according to claim 43, wherein the at least one memory and the instructions are further configured to, with the at least one processing circuitry, cause the apparatus at least:
to receive a data packet in one of an uplink direction and a downlink direction; and
to cause transmission of the received data packet to a destination.

49. The apparatus according to claim 43, wherein the apparatus is included in a communication network control element configured to act as at least one of a packet data gateway, traffic detection function and classifier element, which is connectable to an external service providing side by means of an interface.

50. A method including
receiving and processing service policy rules to be used for routing a service data flow to and within at least one external service function or at least one external service function chain;
receiving a data packet in at least one of uplink and downlink direction;
determining whether for the received data packet any service policy rules to be used for routing a service data flow to and within at least one external service function or at least one external service function chain are present;
in case service policy rules to be used for routing a service data flow to and within at least one external service function or at least one external service function chain are present, applying the service policy rules to introducing routing information including a marking in the data packet, wherein the marking indicates service functions or service function chains to be used for the data packet; and
routing the data packet including the routing information via relevant external service functions or external service function chains.

51. The method according to claim 50, further including
receiving information enabling a routing of data packets via at least one external service function or at least one external service function chain, the information including at least one tag or identification element of a respective external service function or external service function chain,
wherein the marking of the data packet includes an insertion of at least one of the received tag or identification element of a respective external service function or external service function chain.

52. The method according to claim 50, wherein the received service policy rules to be used for routing the service data flow to and within at least one external service function or at least one external service function chain include at least one of generic service policy rules and specific policy rules being specific to an attached communication element or user, wherein the generic service policy rules or the specific service policy rules indicate the routing information.

53. The method according to claim 50, further including
preparing routing of later data packets of the same service data flow like the received data packet via the relevant external service function or external service function chain.

54. The method according to claim 53, further including
receiving and processing an acknowledgement for the routing information from an external service function providing side; and
omitting introducing of the routing information in later data packets of the same service data flow.

55. The method according to claim 50, further including
receiving a data packet in one of an uplink direction and a downlink direction; and
causing transmission of the received data packet to a destination.

56. The method according to claim 50, wherein the method is implemented in a communication network control element configured to act as at least one of a packet data gateway, traffic detection function and classifier element, which is connectable to an external service providing side by means of an interface.

57. A computer program product embodied on a non-transitory computer-readable medium, said product, including software code portions for performing the steps of claim 50, when said product is run on the computer.

58. The computer program product according to claim 57, wherein
the computer program product is directly loadable into the internal memory of the computer or transmittable via a network by at least one of upload, download and push procedures.
